(19) United States
(12) Patent Application Publication
(10) Pub. No.: US 2010/0058643 A1
(43) Pub. Date: Mar. 11, 2010

(54) Ownzone Light

(76) Inventors: Eddy Don Morris, Eufaula, AL (US); Roderic Nathan Uphaus, Troy, AL (US)

Correspondence Address: Roderic N. Uphaus, 103 Dendron Av., Troy, AL, 36081, US

(21) Appl. No.: 12/283,187

(22) Filed: Sep. 11, 2008

(51) Int. Cl. A01K 93/00; A01K 97/00

(52) U.S. Cl. 43/17.5

(57) ABSTRACT

A new and improved fish attracting light for use at any depth or location along an angler's fishing line and/or tether line. Said improved light also optionally can employ a slip on float for surface fishing or for depth control of bait. The lighted area produced now becomes the zone of fishing or fisherman's Own Zone. This light consists of a directional line mountable housing. An upper line attachment point and a lower line attachment point directing the light downward and outward. Optionally attachable float mounted over the said light and retained by a threaded removable nut.

### BACKGROUND OF THE INVENTION

1. Field of the Invention

The present invention relates to a new and improved fishing light and or float. This light/float will be universally used by many types of fisherman that incorporates the use of lights for attracting bait fish such as large and small minnows to draw larger pray fish to their bait. The design will be used by recreational fisherman such as bank fisherman and recreational boaters/fisherman as well as charter boats that wish to draw bait fish to their customers. The light is not limited to use in fresh or salt water for bait fish are drawn in both applications. The light is also not limited to surface use or deep water use. The present invention will allow individuals to control their own area or own zone to fish within.

2. General Background of the Invention

Fisherman in general very often employ the use of commercial offered lighting as a source of drawing bait fish such as minnows to the area were they have placed there bated line. Many of these style lights are free standing for use during bank fishing along creeks and rivers where others are mounted to boats or free standing for lake fishing from boats.

The intent of the light is to draw larger more desirable fish to the bait fish which gather around the light. With the light present the angler increases his or her chance of landing or catching the larger fish drawn to the bait fish surrounding the light. In general large fish are drawn to injured easy pray such as would be found bated on a hook displayed by the light. Many sources of said light such as lanterns, both gas and electric, are sold in commercial establishments such as Bass Pro of Springfield Mo., Cabalas of Sidney Nebr. and Wal-Mart of Bentonville, Ark. Generators are often used to provide power for higher powered lights either permanently mounted or free standing both on shores and boats.

The individual placement of such lights by each fisherman becomes very desirable for it raises their probability of catching larger fish. The ownership of said territory or zone established by the light becomes even more valuable to the angler therefore the following invention is introduced.

### BRIEF SUMMARY OF INVENTION

The present invention enhances the opportunity for the typical angler to increase their harvest by the introduction of their Ownzone of controlled lighted area. The introduction of light directed downward and outward as well as positioned at any depth the angler desires attracts bait fish followed by the targeted fish to the anglers lure.

In addition to positioning the light at any depth the angler desires, a secondary float can be positioned over the outside of the said light and retained by a finger tightened nut. Said light and float assembly now provides the ability for the angler to adjust and maintain the depths of the desired bait. In addition to controlling the depths of the desired bait the angler now has the ability to direct light as an attractant to other bait fish such as minnows, fingerlings, and adolescent fish of all types. Controlling said depth and light produces the angler's Ownzone of fishing.

The present invention employs the use of electrical batteries, compact LED lights, and electronics, housed within a plastic tubular member. Said tubular plastic housing extends generally downward. Within the tubular portion of the housing is a seat, or a shelf-like area. This area is located generally to the lower end of the plastic tube. Within said plastic tube are internal threads located at the uppermost portion of the tube. Said threads extend approximately 25% of the tube's length.

Housed within said tube is an LED light assembly which locates against shelf-like area located generally to the lower end of the plastic tube.

The LED light assembly employs an insulating disc and an insulated electrical contact lead as well as a centered contact located in the center of the disc. When positioned within said tube and located against said shelf-like area the LED light and disc become sealed against said shelf-like area.

The LED light assembly is then followed by four generally round and wafer shaped batteries. An insulated electrical contact lead follows generally upward and along the outside edge of the batteries but retained within said tube. Located above said batteries is a ring shaped insulator. Said insulated electrical contact lead extends alongside and beyond the ring shaped insulator. The portion which extends beyond the ring shaped insulator is non-insulated to allow electrical conduction.

Positioned above the insulating ring and contacting the electrical contact lead is a generally conical compression spring. Said conical spring is an extended portion of the above upper line latch body assembly. This said assembly screws into the internal threads located in the upward end of said plastic tube assembly.

Protruding from the lowermost portion of the upper line latch body assembly is a generally cylindrical component symmetrically machined on each end to produce a shoulder centered within the component. One protruding end of component is located within the lowermost portion of the line latch body assembly. The small upward diameter of said conical spring locates over and attaches to the opposite extended portion of the above upper line latch body assembly.

Located within said conical spring and over said shoulder is a symmetrical compression spring. Said compression spring rests in a recessed position within the outer conical compression spring.

Upper line latch body assembly is screwed into lower tube assembly until electrical contact is made between the large diameter of conical spring. Further rotation of said line latch body assembly furthers the compression of the conical spring allowing contact of said internal symmetrical compression spring with the batteries. Upon contact with said batteries electrical circuit is complete and the LED light illuminates.

Located externally on the line latch assembly generally centered is a threaded portion. Above threaded portion is a generally tapered portion. Located above this tapered portion is a symmetrical portion extending approximately 25% of the overall length. Located within this generally symmetrical portion is a groove extending generally inward and upward.

Said groove provides the needed area for the angler's line to attach. Positioned over said symmetrical portion of upper line latch assembly and over said groove is a symmetrical compression spring. Said compression spring when in use retains the angler's fishing line to the upper end of the entire assembly.

Optionally located over said upper line latch assembly is a float. This optional float locates over the lower tube assembly and against a shoulder provided on the upper line latch assembly. Located above said float and on the centered threaded portion of the line latch assembly is the threaded float nut. Threaded float nut is generally round wafer shaped and threaded through the middle. Said nut is designed for finger tightening only.

With the float in position, clockwise rotation of the line latch assembly urges the float to rotate as one line latch assembly around the bottom tube. Located on the external lowermost portion of the light body assembly is a reduced diameter area. The said area extends upwardly approximately one-eighth of the overall length of the lower tube. Positioned over said reduced diameter area is the lower line guide. The lower line guide is a generally metal coil comprised of a larger diameter coil on one end and a smaller diameter coil generally centered but separated by a length of generally straight wire. Large diameter coils of said line guide are slightly smaller on the inside diameter than the diameter of the light body assembly reduced diameter portion. When said large coils of line guide assembly are placed over the reduced portion of the light body housing, friction between the two surfaces is introduced retaining the line guide in position.

Smaller diameter of said line guide now positioned generally centered beneath the light body housing provides an attachment point for the angler's fishing line. Said fishing line is spirally wrapped into the coils of the said line guide. Line becomes positioned within the center of the coils urging the entire assembly to remain in a generally vertical attitude during use. The smaller diameter line guide coils also retract themselves to a closed position, disallowing the escape of the fishing line during use.

### BRIEF DESCRIPTION OF THE DRAWINGS

For further understanding of the nature, objects, and advantage of the present invention, reference should be given to the following drawings, read in conjunction with the following detailed description, wherein the reference numerals denote like elements.

FIG. 1 Perspective side view of complete light and float assembly.

FIG. 2 Perspective side view of complete light assembly with adjacent float and nut.

FIG. 3 Perspective side view of complete light and float assembly with cut away float.

FIG. 4 Perspective side view of line light assembly.

FIG. 5 Perspective cut away side view of line light.

FIG. 6 Exploded side view of line light assembly.

FIG. 7 Perspective side view of the light body housing and line guide mechanism.

FIG. 8 Cutaway view of float.

FIG. 9 Upper prospective side view of the LED light and insulating disc assembly.

FIG. 10 Lower prospective side view of the upper line latch body.

FIG. 11 Prospective side of Electrical contact spring mount, centered electrical contact spring and conical electrical spring.

### DETAILED DESCRIPTION OF THE INVENTION

To best describe the present invention attention should be given to FIG. 1 the overall side prospective view of the complete invention. The embodiment of the complete invention is comprised of 24 Light body housing, 22 Float, 23 float nut, 29 Upper line latch body, 27 line latch spring and 25 Lower line guide.

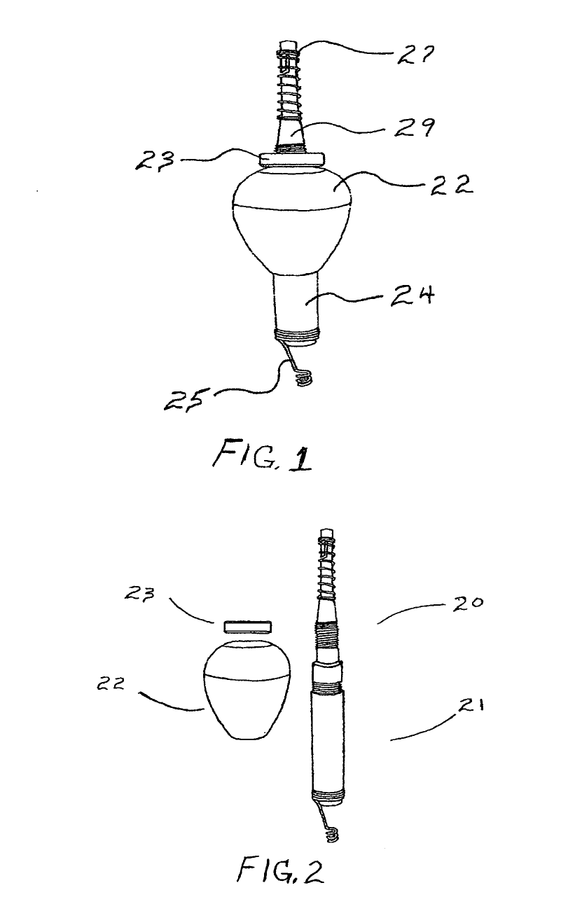

To further describe the embodiment of the preferred invention further attention should be given to 21 light body assembly of FIGS. 2, 3, and 7, and 20 upper line latch body assembly of FIG. 2.

To best describe 21 light body assembly of FIGS. 2, 3, and 7 it should be understood that 21 is a tubular shaped member of the lower light assembly. Said tubular shaped assembly is threaded on the inside diameter of the uppermost portion of the tube best described in 36 of FIG. 5. It should also be noted that the inside diameter of the tubular member employs a step or seat near the lowermost portion of said tube best described by 43 light body housing seat of FIG. 5.

To further describe embodiment of the preferred invention employment of 44 LED light and insulating disc assembly of FIGS. 6, and 9 comprising of 41 light mount disc of FIGS. 5, and 9, 42 LED light bulb of FIGS. 5, 6, and 9 and 39 light power lead of FIGS. 5, 6, and 9 rest upon 43 light bulb housing seat of FIG. 5. It should be noted that within said 41 light mount disc of FIG. 9 exists a centrally located hole passing horizontally through center of said disc best described by 45 of FIG. 9. Said hole provides a passage for 40 LED positive electrical contact of FIGS. 5 and 9. Said disc also employs a 53 groove shaped portion vertically positioned upon the outer disc body best described in FIG. 9, said groove provides an opening for 39 light power lead of FIGS. 5 and 6, and 9 to pass vertically through edge of said disc and upward along the inside of 24 light body housing of FIGS. 1, 4, 6, and 7.

Vertically positioned above 40 LED positive contact of FIGS. 5 and 9 are four (4) generally wafer shaped batteries 38 of FIGS. 5 and 6. said batteries are positioned so that the positive side of one battery contacts the negative side of the opposing battery producing a series thus increasing the battery voltage to the desired amount.

Located vertically above said batteries is 37 insulating ring of FIGS. 5 and 6. 37 insulating ring is employed as an electrical insulating separation between 39 light power lead of FIGS. 5, 6 and 9. 38 batteries of FIGS. 5 and 6. Extending generally vertical between said 37 insulating ring and 24 light body housing and 38 batteries is 39 light power lead. It should be understood that 39 light power lead employs 57 exterior insulation best described in FIG. 9, which exists the length between 41 light mount disc and the uppermost portion of 37 insulating ring of FIG. 5.

Light power lead 39 of FIGS. 5, 6 and 9 employs an uppermost portion of said insulated wire which is free of insulation. Best described by FIG. 47 of FIG. 9. Said insulation free extension of power lead rests on the uppermost portion of 37 insulating ring of FIGS. 5 and 6. It should be noted that the above components described makeup the interior components of 21 light body assembly of FIGS. 2, 3, and 7.

To further describe the preferred embodiment of the invention it should be noted that 20 upper line latch body assembly best described in FIG. 2 is employed within the uppermost threaded portion of 21 light body assembly.

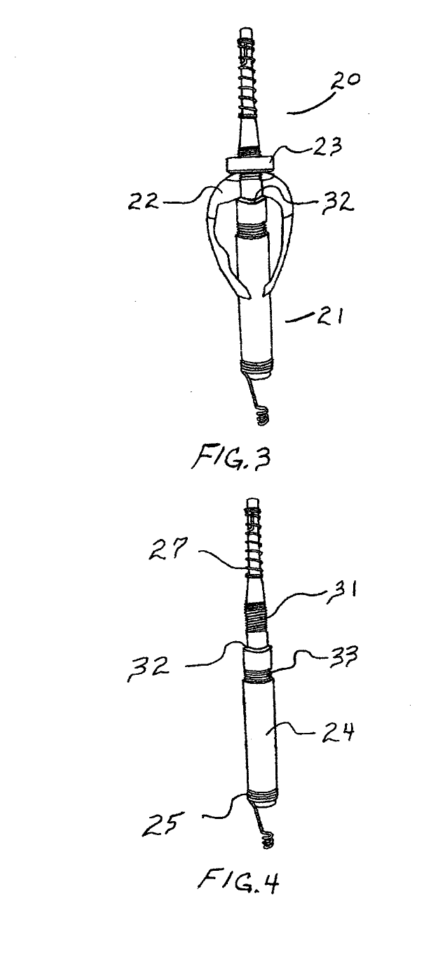

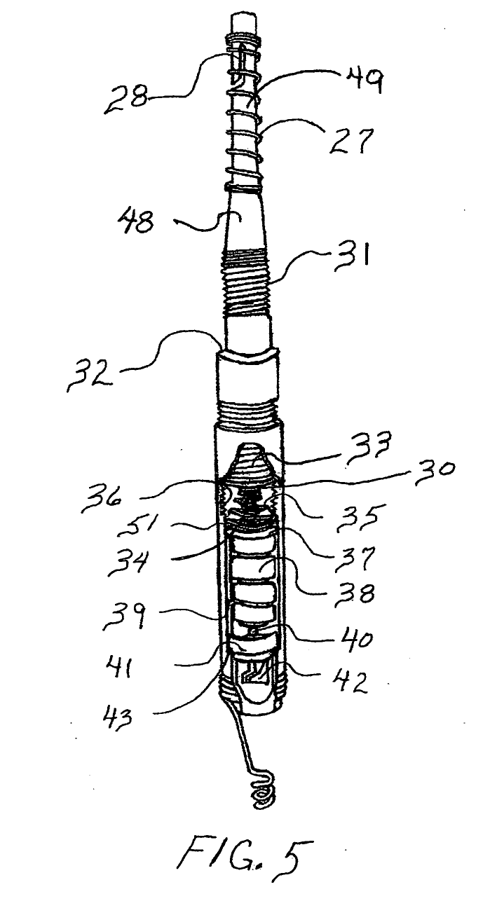

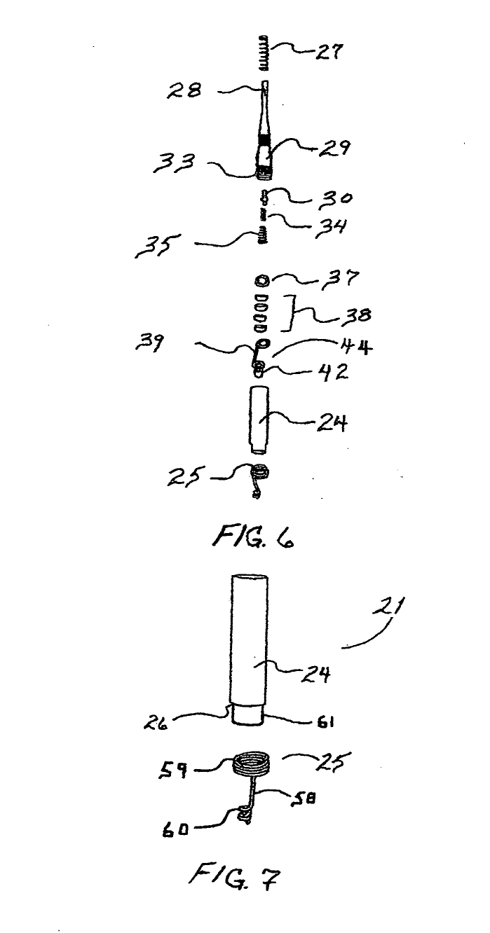

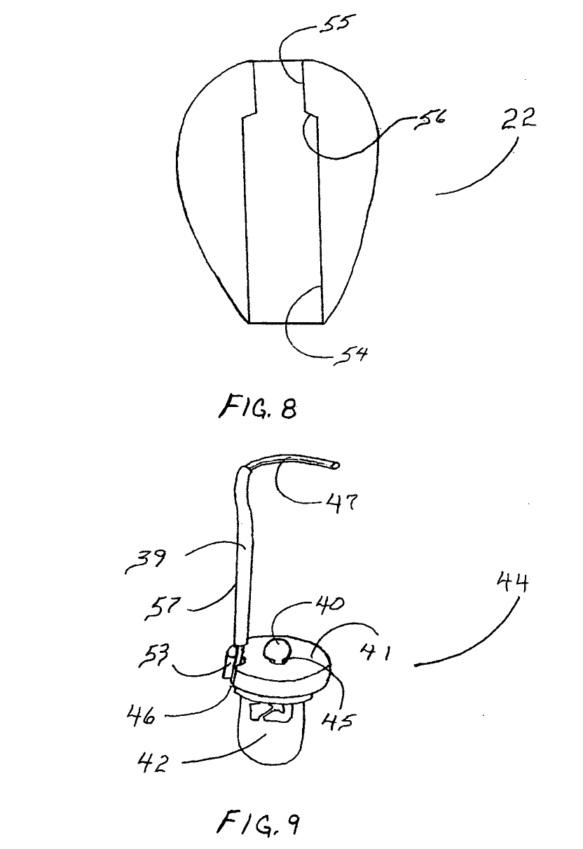

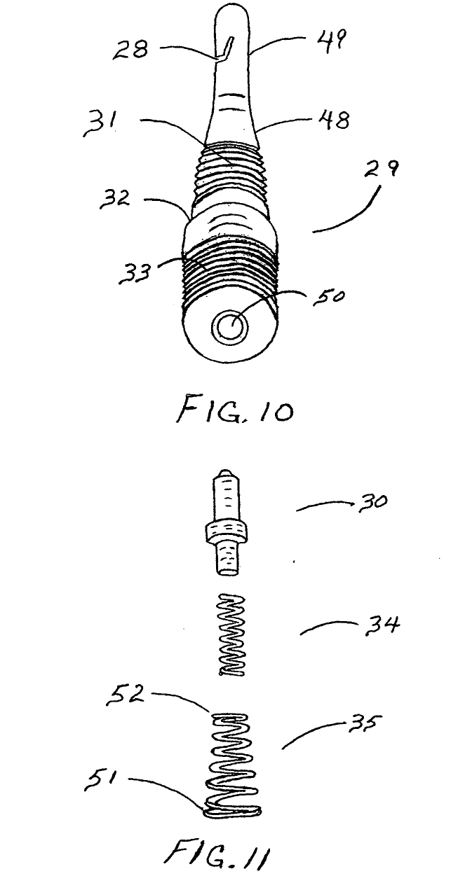

To further describe 20 upper line latch body assembly of FIG. 2 consideration should be given to 29 upper line latch body best described in FIGS. 1, 6 and 10. 29 upper line latch body is generally round and cylindrical in shape employing 33 assembly and light activating threads at the lowermost portion of the of the body, best described in FIGS. 4, 6 and 10. Centrally located within 29 upper line latch body is 31 float nut threads of FIGS. 4, 5 and 10. Extending vertically above said threads is a generally tapered shaped portion 48 of 29 upper line latch body best described on FIGS. 5 and 10.

Protruding generally vertically from 48 tapered area of line latch body extends a generally rod shaped area best described by 49 of FIGS. 5 and 10. Employed within this rod shaped area is 28 line latch groove best described in FIGS. 5, 6, 10. Said line latch groove of 49 rod shaped area is surrounded by 27 line latch spring of FIGS. 1, 4, 5, and 6.

To further describe 29 upper line latch body of FIGS. 1 and 6 it should be noted that a shoulder like area 32 float mount shoulder of FIGS. 3, 4, 5 and 10 is employed.

To further describe 21 line latch body assembly of FIGS. 2, 3, and 7 a centrally located 50 hole, recessed portion exists on the underside lowermost portion of 29 upper line latch body best described in FIG. 10. Positioned within said recessed portion or hole is 30 electrical contact spring mount of FIGS. 5, 6 and 11. 30 electrical contact spring mount is generally cylindrical in shape with a recessed portion on each end best described by FIG. 30 electrical contact spring mount of FIG. 11. 30 electrical contact spring mount is retained within the said 50 hole of 29 by an interference fit.

Positioned below 30 electrical contact spring mount is 34 centered electrical contact spring of FIGS. 5, 6 and 11. 34 centered electrical contact spring is generally symmetrical in length and of the compression style. Inside diameter of said 34 spring is slightly smaller than 30 electrical contact spring mount. 34 centered electrical contact spring is positioned onto and over the protruding portion of 30 electrical contact spring mount. The interference fit created between 30 and 34 affects 34 spring to 30 spring mount.

Located over 34 centered electrical contact spring and onto 30 electrical contact spring mount is 35 conical electrical spring of FIGS. 5, 6 and 11. Said 35 conical electrical spring is positioned onto 30 electrical contact spring mount so as the 52 of FIG. 11, smallest diameter end of 35 conical electrical spring rests upon the centrally positioned shoulder of 30 electrical contact spring mount of FIGS. 5, 6 and 11.

To further describe the preferred embodiment of the invention it should be noted that 20 upper line latch body assembly threads into the uppermost portion of 21 light body assembly of FIGS. 2, 3, and 7.

It should be understood that as 20 upper line latch body assembly threads within 21 line latch body assembly contact is made between the 51 large diameter portion of the conical spring of FIG. 11 and 47 insulation free portion of 39 light power lead best described in 51 of FIG. 5. It should be noted that 34 centered electrical contact spring of assembly 20 being generally shorter in length than 35 conical electrical spring comes in contact with the uppermost portion of 38 batteries of FIGS. 5 and 6 as 20 upper line latch body assembly is threaded into 21 light body assembly. Upon contact of 38 batteries an electrical circuit is completed and the LED light is illuminated. Upon unthreading of 20 upper line latch body assembly and 21 light body assembly the light is extinguished.

To further describe the embodiment of the invention attention should be given to 25 lower line guide of FIGS. 4, 6, and 7 and 24 light body housing best described in FIG. 7. It should be understood that 25 lower line guide typically is comprised of a single strand of wire or light materials wound in opposing cylindrical closed spring shapes best described in FIG. 7. Located between wound cylindrical shapes is 58 a generally straight portion joining said two coils or shapes together.

It should be understood that the 59 uppermost coil portion of 25 lower line guide is generally larger in diameter than the 60 lower most coiled portion of the lower line guide.

To further describe the relationship between 24 light body housing 1, 4, 6, and 7 and 25 lower line guide of FIGS. 4, 6, and 7 a 61 recessed portion of 24 light body housing of FIG. 7 employs a 26 shoulder of FIG. 7.

59 large spring diameter of 25 lower line guide is of slightly smaller inside diameter than the exterior of 61 recessed of 24 light body housing. 59 large coil spring inside diameter is located over 61 and against 26 shoulder of FIG. 7. It should be noted that the difference between the inside diameter of the 59 spring coil provides an interference fit between 24 light body housing and 25 lower line guide.

25 lower line guide of FIGS. 4, 6, and 7 employs 60 small diameter of spring as the angler's line locking receptacle. It should be noted that the coils of 25 lower line guide at 60 on FIG. 7 will be of a design whereas the coils are positioned together allowing the angler's fishing line to be wound between the coils and trapped between the center of the coils.

To further describe the embodiment of the invention an optional float 22 of FIGS. 1, 2, and 3 is introduced. It should be understood that said described Ownzone light can function independently or with optional said float.

To further describe said 22 float, attention should be given to FIGS. 3 and 8 float cutaway view. Said float being generally egg-shaped and having hollow centered portion with an area described by 54 of FIG. 8 slips onto and is placed over 29 upper line latch body assembly best described in FIG. 1. 54 of FIG. 8 being of larger diameter than the outside diameter of 24 light body housing of 1, 4, 6, and 7 is allowed to pass freely over 21 light body assembly. An area 55 of FIG. 8 being of a smaller diameter slips over 31 float nut threads of figure 5 and allows 56 float mount surface to position against 32 float mount shoulder of FIGS. 3, 4, best described in FIG. 3 where contact is made.

Retaining said 22 float onto 29 upper line latch body is 23 threaded float nut. It is to be understood that as 23 threaded float nut in FIGS. 1, 2 and 3 is tightened against 22 float 56 float mounting surface is urged against 32 float mounting shoulder of FIGS. 3, 4, and 5.

To further describe the angler's use of the “Ownzone light and optional float attachment”, it should be understood that the angler's positioning of the Ownzone light onto the fishing line is accomplished by the uppermost portion of 29 upper line latch body. Employment of 28 line latch groove of FIGS. 5, 6 and 10 provides an area to wind the line onto and within 28 line latch groove of FIGS. 5, 6 and 10. 27 line latch spring of FIGS. 1, 4, 5, and 6 is compressed prior to the angler winding the line into 28 line latch groove. Upon the completion of the line winding into 28 line latch groove 27 line latch spring is released thus extending over and compressing the angler's line into 28 line latch groove.

To attach the Ownzone light into a vertical desired position 25 lower line guide of FIGS. 4, 6, and 7 is employed. The angler wraps the fishing line into 60 small diameter spring FIG. 7 until the line becomes centrally located within the spring coils.

The employment of the upper line winding system employing 28 line latch groove and 27 spring, and the employment of 25 lower line guide allows the angler to position the Ownzone light with or without the optional 22 float anywhere desired on their line.

The following is a list of parts best suited to construct the present invention: Part Number

Description
20 upper line latch body assembly light
21 body assembly
22 float
23 float threaded nut
24 light body housing
25 lower line guide
26 light body shoulder
27 line lock spring
28 line latch groove
29 upper line latch body
30 electrical contact spring mount
31 float nut threads
32 float mount shoulder
33 assembly and light activating threads
34 centered electrical contact spring
35 conical electrical spring
36 inside light body threads
37 insulator ring
38 batteries
39 light power lead
40 LED positive contact
41 Light mount disc
42 LED light bulb
43 Light bulb housing seat
44 Led light and insulating disc assembly
45 Center hole through insulating disc
46 Negative LED light lead
47 Noninsulated portion of light power lead.
48 Tapered portion of line latch body.
49 Rod shaped area of line latch body.
50 Mount hole for electrical contact spring mount#30
51 Large diameter end of conical spring
52 Small diameter end of conical spring
53 Groove in disc
54 Large diameter of through hole in float.
55 Small diameter of hole in float.
56 Float mounting surface.
57 Wire insulation
58 Straight portion of lower line guide 25
59 large diameter coil of lower line guide
60 small diameter of lower line guide
61 small diameter of light body housing

What we claim is:

1. A mobile fishing line or tether line mounted, battery powered, vertically positioned, directional bait fish attracting light, used with or without an accessory float attachment. Said light can be positioned vertically at any depth along angler's line or a tether. Said light is not limited to size, for it can also be used as a tethered positional anchored light being of larger size than would be used on a typical fishing rod and reel. Said light source is not limited to LED, fluorescent or incandescent lighting. It is to be understood that this is a independently battery powered light that requires no external power source.
(a) A fishing line or tether line mounted light comprising of an upper line mount and a lower line mount with the intent of vertically mounting the light to the fishing line or tether. Said tether can be independent of a boat, pier, or other fixed structures. Said light can be independently mounted on fish locating buoys along the length of the line.
(b) A fishing line or tether line mounted light with an optionally mounted float for controlling depth of the said light.
(c) A fishing line or tether line mounted, vertically directed fishing light that can be positioned at any depth along the angler's line or tether.

2. A float optionally mounted to a vertically directed bait fish attracting light mounted to a fishing line or tether.
(a) Optionally mounted float being retained to said bait fish attracting light by mechanical fasteners such as threaded nut or retaining clips.
(b) Optionally mounted float of claim 2 be of any size or shape controlling buoyancy.

3. A vertically directed fishing line or tether line mounted light with a lower mount comprising of a spirally wound line mount in which the fishing line is spirally wrapped between the coils and becomes retained within the inside diameters of the wraps of the coil.
(a) A fishing line mount of claim 3 comprising of spirally wrapped coils of metal wire or plastic designed to trap, hold or retain fishing line in position. Said mount is not limited to size in length or diameter.
